(19) United States
(12) Patent Application Publication
(10) Pub. No.: US 2002/0107898 A1
(43) Pub. Date: Aug. 8, 2002

(54) Digital low pass filter

(76) Inventors: Derk Reefman, Eindhoven (NL); Petrus Antonius Cornelis Maria Nuijten, Eindhoven (NL)

Correspondence Address: U.S. Philips Corporation, 580 White Plains Road, Tarrytown, NY, 10591, US

(21) Appl. No.: 09/952,180

(22) Filed: Sep. 14, 2001

(30) Foreign Application Priority Data
Sep. 15, 2000 (EP) 00203208.4

(51) Int. Cl. G06F 17/10

(52) U.S. Cl. 708/300

(57) ABSTRACT

A digital low pass filter of the FIR type stores the input signal into register means with a plurality of taps. These taps are connected to address a look up table and the filtered output signal is derived from the output of the look up table. The filter may e.g. be used in systems where a one-bit direct stream digital (DSD) signal has to be requantized.

The present invention relates to a digital low pass filter comprising register means with a plurality of taps to which register means a digital input signal is applied and from whose taps a series to parallel converted signal is obtained and means for deriving, from the series to parallel converted signal, a low pass filtered output signal. Such kind of filter, wherein the output signal of each tap is multiplied with a coefficient in a coefficient-multiplier and wherein the output signals of all coefficient-multipliers are summed to constitute the low pass filter output signal, is well known in the art e.g. from the book “Digitale Signaalbewerking” of A. W. M. van den Enden and N. A. M. Verhoekx, and belongs to the category of filters usually referred to as a finite impulse response filters.

For low pass filtering digital signals, often infinite impulse response (IIR) filters are used. However, in some cases finite impulse response (FIR) filters are preferred, because the group delay of FIR filters, especially symmetrical FIR filters, is more constant and because the word length of the signals in a FIR filter is usually smaller than in IIR filters. However, the above described FIR filter, despite its advantages, is not very suitable to filter digital signals with high sampling rates, because the multiplication operations are relatively time consuming. Substantially increasing the processing speed of such filter would require higher power consumption and larger chip area, which is often not acceptable.

Therefore, it is the primary object of the invention to provide a digital low pass filter of the above described kind, which is faster in operation and which is therefore able to handle digital signals with a relatively high sampling rate and the digital low pass filter of the present invention is therefore characterized by a look up table, which is addressed by the series to parallel converted signal and by means to derive the low pass filter output signal from the so addressed look up table. The basic idea of this invention is that the combination of bits provided by the taps of the register means and belonging to a plurality of samples of the input signal, forms a digital word. This digital word can than advantageously be used to address a look up table.

The low pass filter of the present invention is especially suitable for those input signals having a small word length, because usually the smaller the word length the higher the sampling rate is. More particularly, the invention may be used advantageously in those applications where single-bit bitstream signals have to be filtered where the digital input signal has a word-length of 1.

An important application for the low pass filter of the present invention is in Super Audio Compact Disc (SACD®) systems, where single-bit signals have often to be requantized e.g. for the purpose of mixing two signals, or for compressing/decompressing such signals or for error concealment in such signals. In those applications the single bit signals have to be low pass filtered prior to the requantization, which can e.g. be performed in a sigma-delta-modulator. Examples of those applications are described in applicants prior filed European patent applications (ID 602583 and ID 602604).

It will be apparent that the number of taps of the register means determines the word length of the signal with which the look up table is addressed and consequently the number of the different values which can be obtained from the look up table. For instance, when the register means has 16 taps, the look up table is addressed by 16-bit words and can then provide 2^{≠}=65536 different values of output signal. The higher this value is, the higher the resolution of the filtered output signal can be but each more tap would double the magnitude of the look up table.

However, it may be considered as a disadvantage that a large memory has to be used when a sufficiently high resolution has to be achieved. This disadvantage may be substantially minimized when, according to a further aspect of the invention, the digital low pass filter of the invention is further characterized in that the register means are divided into a plurality of registers, that each of the registers is arranged to address one of a plurality of look up tables and that the results of the addressing of the look up tables are added to derive the low pass filtered output signal. Therefore, in stead of a single look up table of e.g. 65536 locations, which is addressed by 16 register taps, the filter may comprise e.g. two look up tables of 256 locations each, which are each addressed by 8 taps of the shift register means. Then, at the cost of one more addition operation, the total numbers of locations is reduced to 512. Because the two look up tables are addressed independently from each other, the low pass filter may still provide up to 65536 different results.

A further increase of the ability to handle input signals with high sampling rates may be obtained when the digital low pass filter of the invention is further characterized in that one of the plurality of registers is loaded by the digital input signal and the other registers are parallel loaded from said one register at a rate which is equal to the sampling rate of the digital input signal divided by the number of samples stored in each of said plurality of registers. In this way a kind of down-sampling is obtained for the addressing- and addition-operations. When the output signal of the filter has to be available at the original sampling rate of the input signal, an up-sampling at the output has to take place with the result that the up-sampled signal is kept constant during a plurality of samples and then jumps to the new value. This operation resembles a sample and hold operation which results in an output signal having a staircase character.

If such a staircase output signal is undesired, because it contributes to the noise level of the signal, an improvement may be achieved by interpolation. To this end the digital low pass filter of the invention may still further be characterized by means to recover from the addressing of the plurality of look up tables two successive values of the low pass filtered output signal and means to derive from said successive values of the low pass filtered output signal intermediate values at a rate which is equal to the sampling rate of the digital input signal.

The number of samples to be stored in each of the plurality of registers and consequently the word length of the addresses of the look up tables may be any suitable number, however preferably said number is equal to eight, because this choice allows the use of standard, fast and easily available byte-oriented circuitry.

Another choice is the word length of the digital signals stored in the look up table and delivered to the output of the digital filter. The larger the output word length is, the more accurate the value of the output signal can be and the less noise is introduced by the filter. On the other hand the word length should be adapted to the arrangement which receives the filtered signal. E.g. when the filter is followed by a sigma-delta-requantizer, the output word length should be equal to the word length to which the filters in the requantizer are designed. Therefore, the invention also relates to a system for processing single bit digital signals comprising a requantizer which is preceded by a digital low pass filter according to the present invention.

The invention will be further explained with reference to the attached figures. Herein shows:

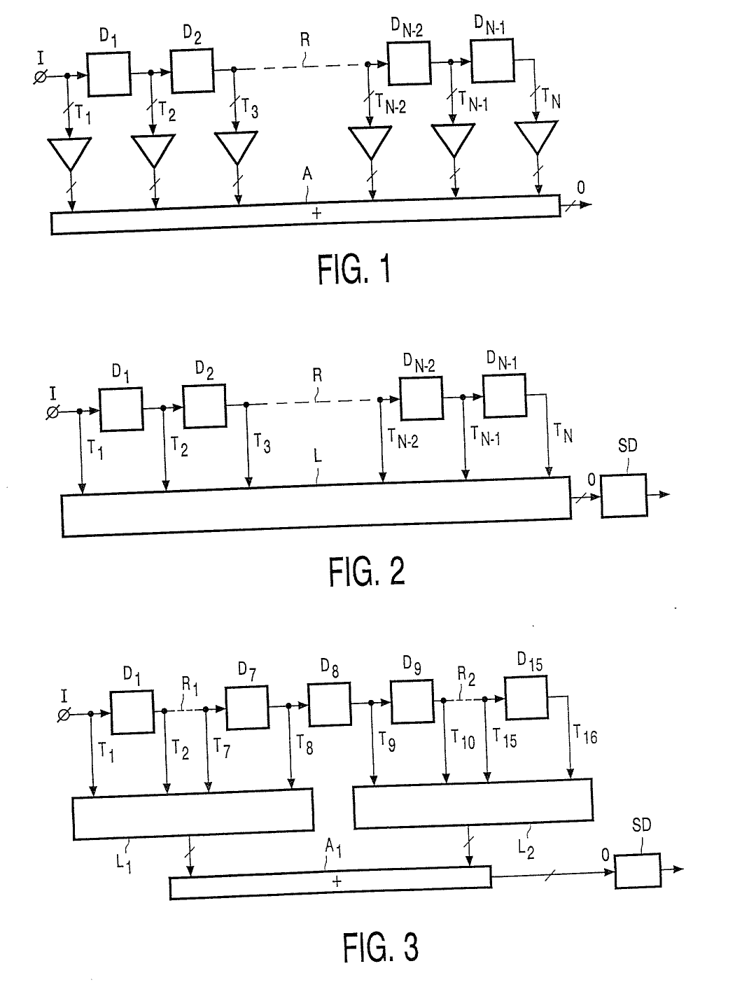

FIG. 1 a prior art digital low pass filter and

FIG. 2, 3, 4, and 5 different embodiments of a digital low pass filter in accordance with the invention in a system for requantizing single bit signals.

The prior art low pass filter of FIG. 1 comprises a shift register R to which a digital input signal is applied through an input terminal I. The shift register R consists of N−1 delay elements D₁ . . . D_{N-1,} each of which delays the input signal by one period Tₛ, of the sample rate. The output of the shift register R consists of N taps P₁. . . P_{N}, so that the signal at each tap is delayed by one period Tₛ, with respect to the signal at the previous tap. Each of the tap-signals is applied to a coefficient multiplier C₁, . . . C_{N} and the output signals of these multipliers are added in an adder A to constitute the filtered output signal at an output terminal O.

In practice this low pass filter may e.g. be used to filter audio signals having a sample rate of 44.1 kHz and a word length of 14 bits. The multipliers C₁. . . C_{N} and the adder A increase the word length so that the output signal at the output terminal O may have a word length of e.g. 20 bits. The coefficients of the multipliers C₁. . . C_{N} determine the characteristics of the filter, such as cut off frequency, ripple and group delay. Preferably the filter is symmetrical (C₁=C_{N}, C₂ =C_{N-1}, etc.) because in that case the group delay of the filter is constant.

The filter of FIG. 1 is not suitable for filtering digital input signals having a substantially higher sampling rate, such as the DSD (Direct Stream Digital) format which is used for the Super Audio CD (SACD®) format. This is a one bit signal format with a sampling rate of 64*44.1 kHz=2.8224 Mhz. With present technics the multiplication/addition operation of the filter of FIG. 1 cannot economically be done fast enough.

In the digital low pass filter of FIG. 2 the multipliers C₁. . . C_{N} and the adder A of FIG. 1 are replaced by a look up table L which is addressed by the N-bit digital word from the taps T₁, . . . T_{N} of the register R. The output of the look up table L constitutes the output of the filter. Often, DSD format signals have to be requantized and to this end the filter output signal may be applied to a sigma-delta modulator SD. Because the addressing of the look up table in the arrangement of FIG. 2 requires less time than the multiplication and addition operation in the arrangement of FIG. 1, the filter of FIG. 2 can handle substantially higher sampling rates.

The values, stored in the look up table, can be chosen such that the filter characteristics are identical to those of FIG. 1. With other words, the design of the filter of FIG. 2 can be done by firstly designing the coefficients C₁. . . C_{N} of the filter of FIG. 1 in the usual way, and then calculating therefrom the contents to be stored in the look up table.

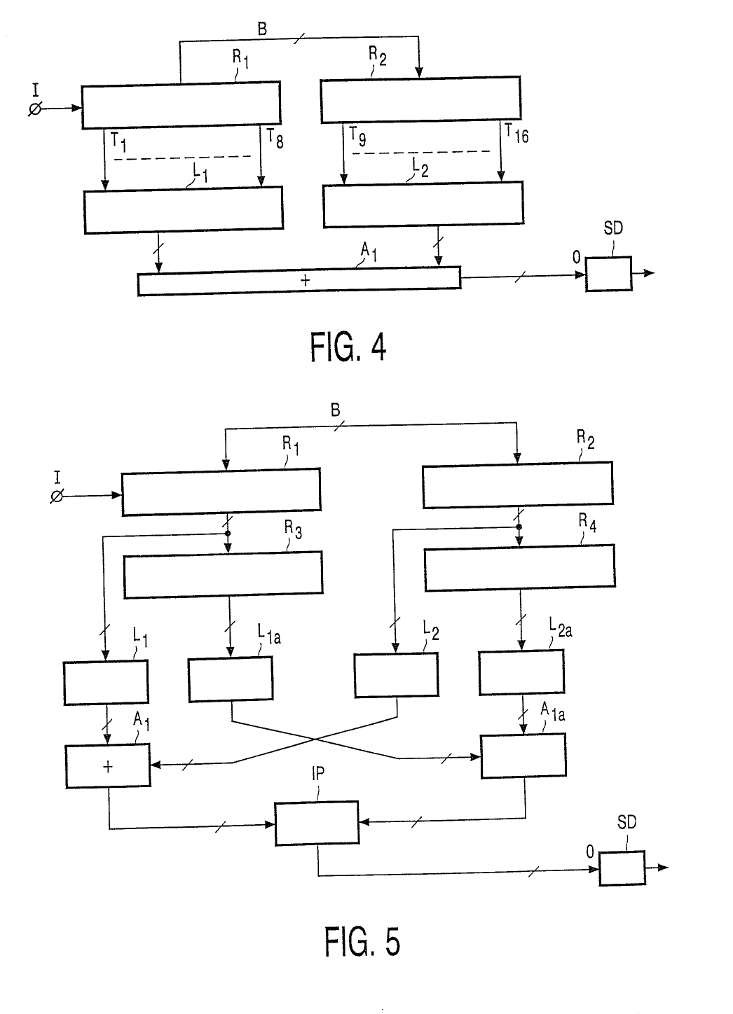

As is already observed in the preamble, the arrangement of FIG. 2 requires a relatively large look up table. With a practical value of N=16 the look up table contains 2¹⁶=65536 locations. A substantial reduction of the size of the look up table is obtained with the arrangement of FIG. 3 wherein, as in FIGS. 4 and 5, by way of preferred example, the total number of taps N of the register means is chosen equal to 16.

In the arrangement of FIG. 3 the look up table L of FIG. 2 is split up into two smaller look up tables L₁ and L₂. The look up table L₁ is addressed by the first half T₁. . . T₈ of the register taps and the look up table L₂ is addressed by the second half T₉. . . T₁₆ of the register taps. The output signals of the two look up tables are added in an adder Al. A₁ Because each of the look up tables L₁ and L₂ is addressed by only 8 taps, these look up tables each have only 2⁸=256 locations, so that a substantial reduction of a factor 128 in locations is obtained. Nevertheless, because the look up tables are addressed independently from each other, the output signal delivered by the adder A₁ may still have 65536 different values.

A low pass filter with a further improved handling of high speed sampling rates is represented in FIG. 4. In this figure corresponding elements with those of FIG. 3 have been given corresponding references. The register D₁. . . D₁₅ of the arrangement of FIG. 3 has been split up into two registers R₁ and R₂ in which register R₁ comprises the delay elements D₁. . . D₇ and register R₂ the delay elements D₉. . . D₁₅. Delay element D₈ is left out and instead a parallel 8-bit wide bus B connects register R₂ to register R₁.

In operation, suppose that register R₁ contains a byte b₁. Before a next byte b₂ of 8 bits of the input signal is shifted into register R₁, the byte b₁ is parallel loaded through the bus B into register R₂. When the shift of the byte b₂ into register R₁ is finished, the two look up tables are addressed; look up table L₂ is addressed by byte b₁, look up table L₁ is addressed by byte b₂ and the results of the two address operations are added in adder A₁. Eight sample periods later, the register R₂ contains byte b₂ and register R₁ contains byte b₃ and a new addressing of the two look up tables and a new addition by adder A1 takes place.

Consequently, when E₁ (b₂) denotes the output of look up table L₁, when addressed by byte b₂, and E₂(b₁) denotes the output of look up table L₂, when addressed by byte b₁, then the

adder A₁ delivers the signal E₂(b₁)+E₁ (b₂). Eight sample periods later the adder A₁ delivers the signal E₂(b₂)+E₁ (b₃) and so on.

When the sampling rate of the input signal is denoted by fₛ, the rate at which the bytes are transferred, the look up tables are addressed and the adder A₁ operates is fs/8, so that a down-sampling with a factor 8 has taken place. Because the requantizer SD needs an input signal at the original sampling rate fₛ, up-sampling has to take place at the output of the adder A₁, which means that eight times the same signal level is outputted to the requantizer SD before the signal is refreshed, thereby giving the signal a staircase character. Therefore, the arrangement of FIG. 4 performs a down-sampled low pass filtering and up-sampling and hold at the output.

If the sample and hold action at the output of the lowpass filter of FIG. 4 gives a too noisy signal, an improvement may be achieved by an interpolation operation at the output of the filter. An example hereof has been depicted in FIG. 5 in which corresponding elements with those of FIG. 4 have been given corresponding references. The low pass filter of FIG. 5 comprises an additional register R₃ coupled to register R₁ and an additional register R4 coupled to register R₂. Furthermore two additional look up tables L₁ₐ and L₂ₐ are provided which have the same content as the look up tables L₁ and L₂ respectively. While the outputs of the look up tables L₁ and L₂ are added in an adder A₁, the outputs of the look up tables L₁ₐ and L₂ₐ are added in an adder A₁ₐ.

In operation, when a byte b₁ has been shifted into register R₁ this byte is subsequently transferred to register R₂ and to register R₃. Eight sample periods later, when a byte b₂ has been loaded into register R₁, the byte b₁, in R₂ is transferred to R₄ and the byte b₂ in R₁ is transferred to R₂ and R₃. Again eight sample periods later, when a byte b₃ has been loaded into R₁—and before the bytes are transferred to other registers—the respective look up tables are addressed: L₁ is addressed by byte b₃ from R₁, L₂ is addressed by byte b₂ from R₂, L₁ₐ is addressed by byte b₂ from R₃ and L₂a is addressed by byte b₁, from R₄. Subsequently byte b₂ is transferred from R₂ to R₄, byte b₃ is transferred from R₁ to R₂ and R₃, byte b₄ is shifted into R₁ and so on.

The result of the addressing of the look up tables is that look up table L₁ delivers the signal E₁ (b₃) and look up table L₂ delivers the signal E₂(b₂). These two signals are added in adder A₁ to obtain the signal E₂(b₂)+E₁ (b₃), exactly as was the case in the arrangement of FIG. 4. Additionally look up table L₁ₐ delivers the signal E₁(b₂) and the look up table L₂ₐ the signal E₂(b₁) so that the adder A₁ₐ delivers the signal E₂(b₁)+E₁ (b₂), which is the same as the signal obtained in the arrangement of FIG. 4 eight sampling periods (one sub-sampling period) earlier. The two signals are combined in an interpolator IP, where a linear interpolation between the two signals is performed at the original sampling rate fₛ This

$$\frac{1}{8} [ ( 8 - i ) \{ {E}_{2} ( {b}_{1} ) + {E}_{1} ( {b}_{2} ) \} + i \{ {E}_{2} ( {b}_{2} ) + {E}_{1} ( {b}_{3} ) \} ]$$

interpolation may be expressed by the following formula:

wherein i is an integer increasing from 0 to 8.

Alternative interpolation schemes may be used. E.g. the output of the adder A₁ in FIG. 4 may be stored in a register, so that this output is available during the next sub-sampling period. Then this output of the register and the refreshed output of the adder A₁ may be combined in a linear or nonlinear interpolator.

1. A digital low pass filter comprising register means (R) with a plurality of taps (T) to which register means a digital input signal is applied and from whose taps a series to parallel converted signal is obtained and means for deriving, from the series to parallel converted signal, a low pass filtered output signal, characterized by a look up table (L), which is addressed by the series to parallel converted signal and by means to derive the low pass filter output signal from the so addressed look up table.

2. A digital low pass filter as claimed in claim 1 characterized in that the digital input signal has a word-length of 1.

3. A digital low pass filter as claimed in claim 1, characterized in that the register means are divided into a plurality of registers (R₁, R₂), that each of the registers is arranged to address one of a plurality of look up tables (L₁, L₂) and that the results of the addressing of the look up tables are added (A₁) to derive the low pass filtered output signal.

4. A digital low pass filter as claimed in claim 3, characterized in that one of the plurality of registers (R₁) is loaded by the digital input signal and the other registers (R₂) are parallel loaded from said one register (R₁) at a rate which is equal to the sampling rate of the digital input signal divided by the number of samples stored in each of said plurality of registers (R₁, R₂).

5. A digital low pass filter as claimed in claim 4 characterized by means to recover from the addressing of the plurality of look up tables (L₁, L₂, L₁ₐ, L₂ₐ) two successive values of the low pass filtered output signal and means (IP) to derive from said successive values of the low pass filtered output signal intermediate values at a rate which is equal to the sampling rate of the digital input signal.

6. A digital low pass filter as claimed in claim 3, characterized in that said number of samples stored in each of said plurality of registers (R₁, R₂) is eight.

7. A system for processing single bit digital signals comprising a requantizer which is preceded by a digital low pass filter as claimed in any of the preceding claims.
